(19) United States
(12) Patent Application Publication
(10) Pub. No.: US 2007/0046867 A1
(43) Pub. Date: Mar. 1, 2007

(54) Liquid crystal display with bent pixel color filters

(75) Inventors: Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/510,900

(22) Filed: Aug. 28, 2006

(30) Foreign Application Priority Data
Aug. 26, 2005 (TW) 94129259

(51) Int. Cl. G02F 1/1335

(52) U.S. Cl. 349/106

(57) ABSTRACT

An exemplary liquid crystal display (200) includes a first substrate (220), a second substrate (260), and a liquid crystal layer (240) between the first and second substrates. An array of color filter units (221) is formed at the first substrate, each of the color filter units including bent pixel color filters (222). An array of pixel electrodes (261) is formed at the second substrate, at positions in one-to-one correspondence with the pixel color filters.

### FIELD OF THE INVENTION

The present invention relates to liquid crystal displays, and more particularly to liquid crystal displays having bent pixel electrodes.

### BACKGROUND

Liquid crystal displays (LCDs) have been widely used in the field of monitors and visual display units. For example, liquid crystal display televisions (LCD TVs), mobile phones, and portable computers use LCDs, because the LCD has advantages including lightness in weight, a thin profile, low power consumption, and low radiation. In addition, these kinds of products can provide high luminance and full color display quality.

Referring to FIGS. 11 to 13, a conventional liquid crystal display 100 includes a first substrate 20, a second substrate 60, and a liquid crystal layer 40 interposed between the first and second substrates 20, 60. A multiplicity of color filter units 21 are formed on the first substrate 20. Each color filter unit 21 includes a red (R), a green (G), a blue (B), and a white (W) rectangular pixel color filter 22 arranged side by side. The color filter units 21 are arranged in a regular array, such that same-colored pixel color filters 22 of each two adjacent color filter units 21 one above the other are arranged end-to-end. Thereby, a same-colored pixel color filter 22 of each of multiple color filter units 21 aligned along a vertical direction forms a part of a vertical stripe of the one color. A plurality of pixel electrodes 61 are formed on the second substrate 60 at positions in one-to-one correspondence with the pixel color filters 22.

The boundary region between two adjacent side by side pixel color filters 22 is substantially linear. This means that the so-called color mix effect between each two adjacent pixel color filters 22 one beside the other is generally not sufficient. Thus, the liquid crystal display 100 may not be able to achieve high color display quality.

Accordingly, what is needed is a liquid crystal display configured to be able to provide high color display quality.

### SUMMARY

An exemplary liquid crystal display includes a first substrate, a second substrate, and a liquid crystal layer between the first and second substrates. A plurality of color filter units is formed at the first substrate, each of the color filter units including a plurality of bent pixel color filters. A plurality of pixel electrodes is formed at the second substrate, at positions in one-to-one correspondence with the pixel color filters.

Another exemplary liquid crystal display includes a first substrate, a second substrate, a liquid crystal layer between the first and second substrates, a plurality of color filter units, and a plurality of pixel electrodes. The color filter units are formed at the first substrate, and each color filter unit includes a plurality of bent pixel color filters. The pixel electrodes are formed at the second substrate at positions in one-to-one correspondence with the pixel color filters, thereby defining a plurality of pixel regions. Each pixel region includes a transmission region and a reflection region.

Unlike in the prior art, the boundary of the region between each two adjacent bent pixel color filters one beside the other is non-linear. Thus the so-called color mixing region is increased, and the color mix effect and the corresponding color display quality of the liquid crystal display are enhanced.

A detailed description of embodiments of the present invention is given below with reference to the accompanying drawings.

### BRIEF DESCRIPTION OF THE DRAWINGS

Embodiments of the invention can be more fully understood by reading the subsequent detailed description and examples with references made to the accompanying drawings. In the drawings, all the views are schematic.

FIG. 1 is a side cross-sectional view of part of a liquid crystal display in accordance with a first embodiment of the present invention.

FIG. 2 is a top plan view of some of color filter units of the liquid crystal display of FIG. 1.

FIG. 3 is a top plan view of some of pixel electrodes of the liquid crystal display of FIG. 1.

FIG. 4 is a top plan view of color filter units of part of a liquid crystal display according to a second embodiment of the present invention.

FIG. 5 is a top plan view of color filter units of part of a liquid crystal display according to a third embodiment of the present invention.

FIG. 6 is an enlarged, top plan view of another embodiment of a pixel electrode and a common electrode of the liquid crystal display of FIG. 1.

FIG. 7 is a side cross-sectional view of part of a liquid crystal display in accordance with a fourth embodiment of the present invention.

FIG. 8 is a top plan view of one of color filter units of the liquid crystal display shown in FIG. 7.

FIG. 9 is a top plan view of a color filter unit of a liquid crystal display according to a fifth embodiment of the present invention.

FIG. 10 is a top plan view of a color filter unit of a liquid crystal display according to a sixth embodiment of the present invention.

FIG. 11 is a side cross-sectional view of part of a conventional liquid crystal display.

FIG. 12 is a top plan view of some of color filter units of the liquid crystal display of FIG. 11.

FIG. 13 is a top plan view of some of pixel electrodes of the liquid crystal display of FIG. 11.

### DETAILED DESCRIPTION OF PREFERRED EMBODIMENTS

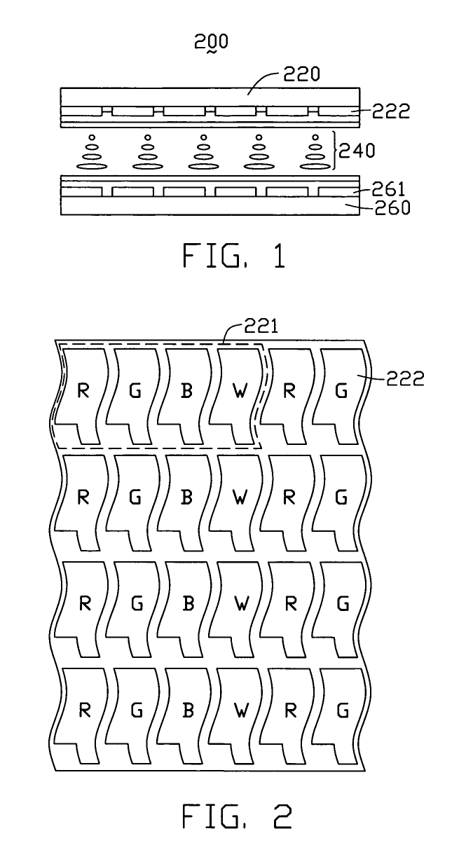

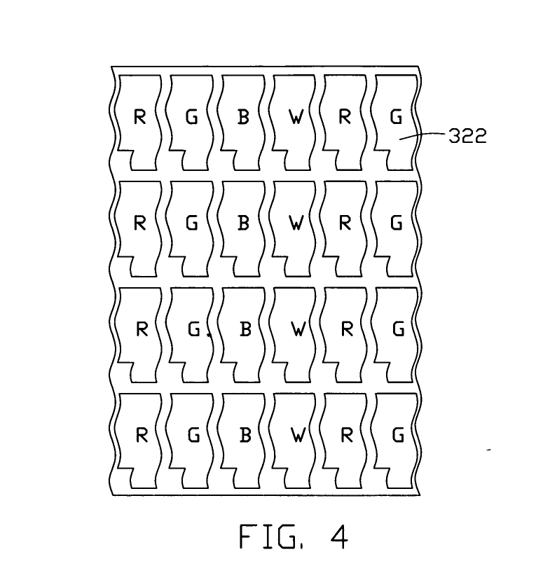

Referring to FIGS. 1 to 3, a liquid crystal display 200 in accordance with a first embodiment of the present invention includes a first substrate 220, a second substrate 260, and a liquid crystal layer 240 interposed between the first and second substrates 220, 260. A plurality of color filter units 221 are formed on the first substrate 220. Each color filter unit 221 includes a red (R), a green (G), a blue (B), and a white (W) pixel color filter 222 arranged side by side. Each of the pixel color filters 222 has a same generally S-shaped configuration. In the illustrated embodiment, each pixel color filter 222 has a same gently S-shaped configuration. A plurality of pixel electrodes 261 are formed on the second substrate 260 at the positions in one-to-one correspondence with the pixel color filters 222. Thus each of pixel regions (not labeled) of the liquid crystal display 200 includes a pixel color filter 222 and a pixel electrode 261. The pixel electrode 261 has generally S-shaped configurations similar to the configuration of the corresponding pixel color filter 222. In an alternative embodiment, the pixel color filter 222 and the pixel electrode 261 in each pixel region can have generally rectilinearly bent configurations. For example, the pixel color filter 222 and the pixel electrode 261 can be generally zigzagged (e.g., gently zigzagged). The pixel electrodes 261 are made from transparent electrically conductive material, such as indium tin oxide or indium zinc oxide.

The boundary region between each two adjacent pixel color filters 222 one beside the other is non-linear. Thus the color mixing region is increased, and the color mix effect and the corresponding color display quality of the liquid crystal display 200 are enhanced.

Referring to FIG. 4, this is a top plan view of color filter units of part of a liquid crystal display according to a second embodiment of the present invention. The second embodiment is similar to the above-described first embodiment. However, the second embodiment includes a plurality of pixel color filters 322. The pixel color filters 322 are generally wavelike. In an alternative embodiment, the pixel color filters 322 can be curved. For example, the pixel color filters 322 can be arcuate or arc-shaped.

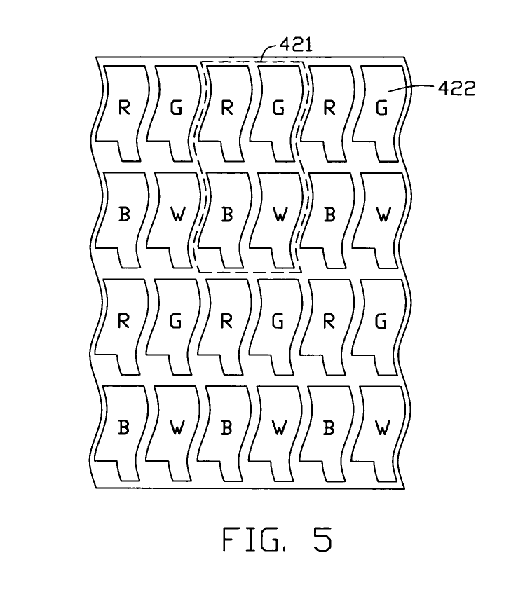

Referring to FIG. 5, this is a top plan view of color filter units of part of a liquid crystal display according to a third embodiment of the present invention. The third embodiment is similar to the above-described first embodiment. However, the third embodiment includes a plurality of pixel color filters 422. Each color filter unit 421 includes a red, a green, a blue, and a white pixel color filter 422 arranged in a 2×2 matrix.

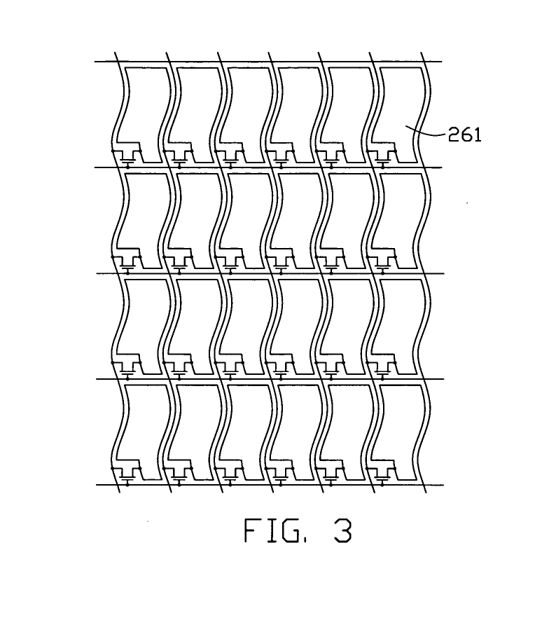

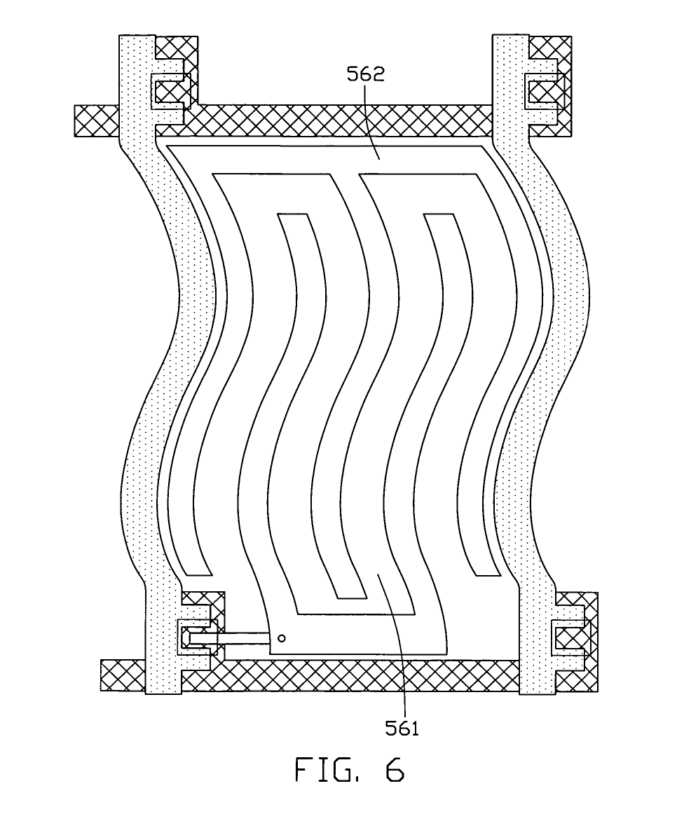

Referring to FIG. 6, this is an enlarged, top plan view of another embodiment of a pixel electrode and a common electrode of one pixel region of the liquid crystal display 200 of the first embodiment. Referring also to FIGS. 1 and 2, the pixel electrode 561 and the common electrode 562 are formed on the second substrate 260. The pixel electrode 561 and the common electrode 562 each have generally S-shaped configurations similar to the configuration of a corresponding embodiment of the pixel color filter 222 of the pixel region. The pixel electrode 561 and the common electrode 562 are made from transparent electrically conductive material, such as indium tin oxide or indium zinc oxide. In an alternative embodiment, the pixel electrode 561 and the common electrode 562 can be curved. For example, the pixel electrode 561 and the common electrode 562 can be arcuate or arc-shaped.

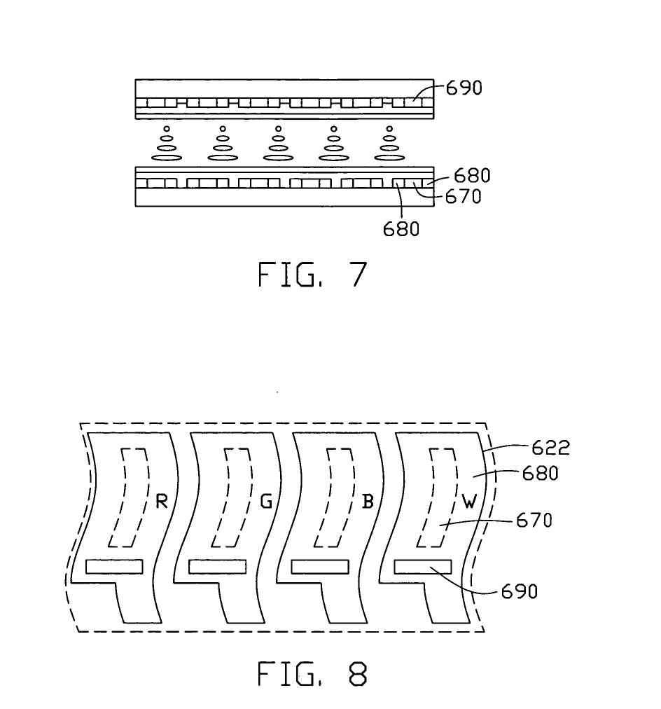

Referring to FIG. 7 and FIG. 8, these are views of parts of a liquid crystal display according to a fourth embodiment of the present invention. The fourth embodiment is similar to the above-described first embodiment. However, in the fourth embodiment, each of the pixel regions includes a transmission region 670 and a reflection region 680. In the illustrated embodiment, the transmission region 670 is surrounded by the reflection region 680. The reflection region 680 is generally S-shaped, and the transmission region 670 is curved to follow the curvature of the reflection region 680. Light emitted from a backlight (not shown) under the liquid crystal display passes through the transmission region 670. Light from outside of (above) the liquid crystal display is reflected by the reflection region 680. Each of color filter units (not labeled) includes a red, a green, a blue, and a white pixel color filter 622 arranged side by side. Each of the red, green, blue, and white pixel color filters 622 includes a through hole 690. The through holes 690 are rectangular. The through holes 690 can increase an amount of light that passes through the pixel color filters 622.

In alternative embodiments, in each pixel region, the reflection region 680 can be surrounded by the transmission region 680. In addition, the pixel color filters 622 in each pixel region can have generally rectilinearly bent configurations. For example, the pixel color filters 622 can be generally zigzagged (e.g., gently zigzagged). Further, the through holes 690 can be circular, elliptic, ovoid, oval-shaped, etc.

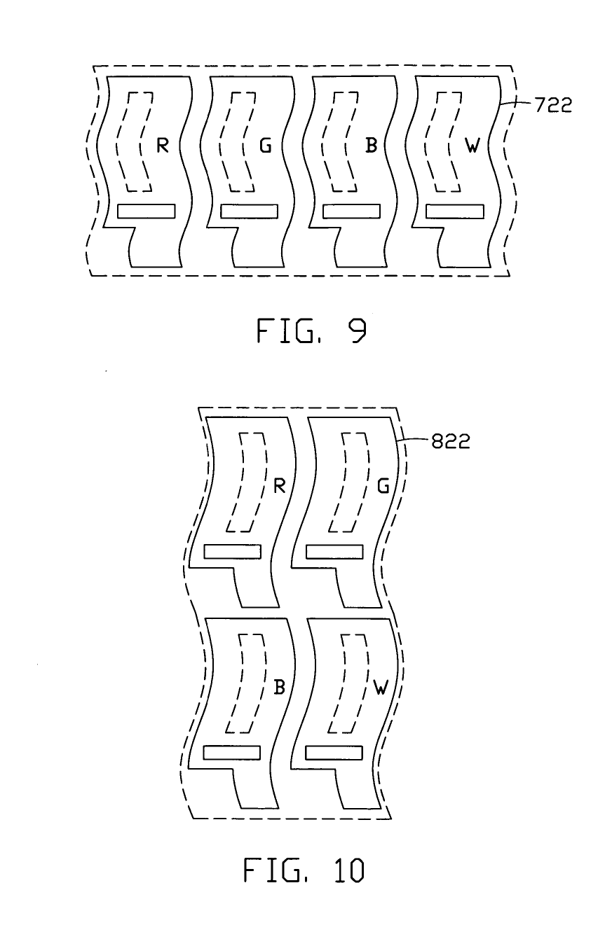

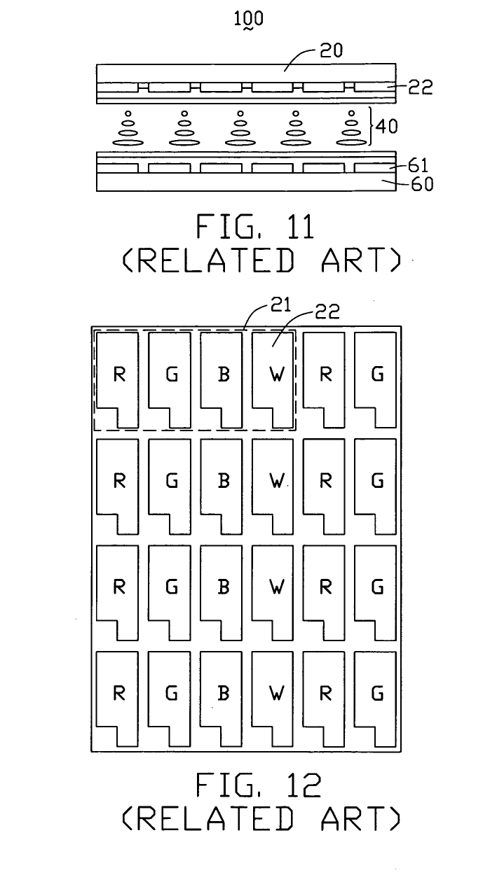

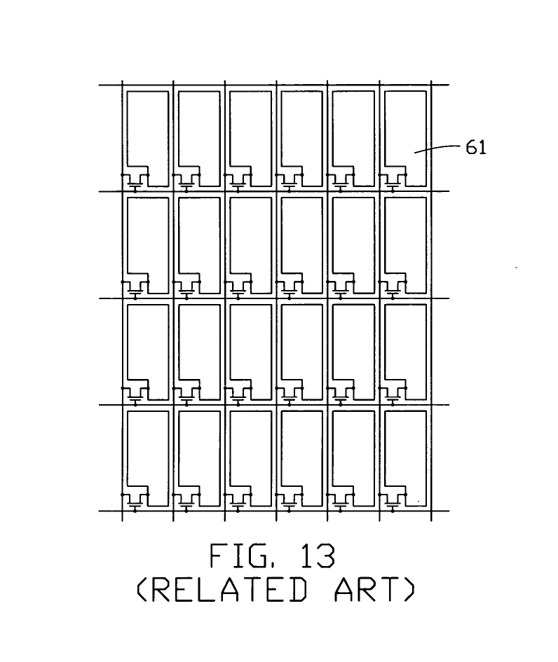

Referring to FIG. 9, this is a top plan view of a color filter unit of a liquid crystal display according to a fifth embodiment of the present invention. The fifth embodiment is similar to the above-described fourth embodiment. However, the fifth embodiment includes a plurality of pixel color filters 722, which are generally wavelike. In an alternative embodiment, the pixel color filters 722 can be curved. For example, the pixel color filters 722 can be arcuate or arc-shaped.

Referring to FIG. 10, this is a top plan view of a color filter unit of a liquid crystal display according to a sixth embodiment of the present invention. The sixth embodiment is similar to the above-described fourth embodiment. However, the sixth embodiment includes a plurality of red, green, blue, and white pixel color filters 822. The pixel color filters 822 of each color filter unit (not labeled) are arranged in a 2×2 matrix.

While the invention has been described by way of examples and in terms of preferred embodiments, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display, comprising:
a first substrate;
a second substrate;
a liquid crystal layer between the first and second substrates;
a plurality of color filter units formed at the first substrate, each of the color filter units comprising a plurality of bent pixel color filters; and
a plurality of pixel electrodes formed at the second substrate at positions in one-to-one correspondence with the pixel color filters.

2. The liquid crystal display as claimed in claim 1, wherein each of the color filter units comprises a red pixel color filter, a green pixel color filter, a blue pixel color filter, and a white pixel color filter.

3. The liquid crystal display as claimed in claim 2, wherein the red pixel color filter, the green pixel color filter, the blue pixel color filter, and the white pixel color filter are arranged side by side.

4. The liquid crystal display as claimed in claim 2, wherein the red pixel color filter, the green pixel color filter, the blue pixel color filter, and the white pixel color filter are arranged in a 2×2 matrix.

5. The liquid crystal display as claimed in claim 1, wherein the pixel electrodes have bent configurations corresponding to the pixel color filters.

6. The liquid crystal display as claimed in claim 1, wherein the pixel color filters are generally S-shaped, wavelike, curved, or rectilinearly bent.

7. The liquid crystal display as claimed in claim 1, wherein the pixel color filters are wavelike.

8. The liquid crystal display as claimed in claim 5, further comprising a plurality of common electrodes formed at the second substrate at positions corresponding to the pixel electrodes, wherein the common electrodes have configurations corresponding to the pixel electrodes.

9. A liquid crystal display, comprising:
a first substrate;
a second substrate;
a liquid crystal layer between the first and second substrates;
a plurality of color filter units formed at the first substrate, each of the color filter units comprising a plurality of bent pixel color filters; and
a plurality of pixel electrodes formed at the second substrate at positions in one-to-one correspondence with the pixel color filters, thereby defining a plurality of pixel regions;
wherein each of the pixel regions comprises a transmission region and a reflection region.

10. The liquid crystal display as claimed in claim 9 wherein each of the color filter units comprises a red pixel color filter, a green pixel color filter, a blue pixel color filter, and a white pixel color filter.

11. The liquid crystal display as claimed in claim 10, wherein the red pixel color filter, the green pixel color filter, the blue pixel color filter, and the white pixel color filter are arranged side by side.

12. The liquid crystal display as claimed in claim 10, wherein the red pixel color filter, the green pixel color filter, the blue pixel color filter, and the white pixel color filter are arranged in a 2×2 matrix.

13. The liquid crystal display as claimed in claim 9, wherein each of the pixel color filters comprises a through hole.

14. The liquid crystal display as claimed in claim 9, wherein the pixel color filters are generally S-shaped, wavelike, curved, or rectilinearly bent.

15. The liquid crystal display as claimed in claim 9, wherein the pixel color filters are wavelike.

16. The liquid crystal display as claimed in claim 9, wherein the transmission region is surrounded by the reflection region.

17. The liquid crystal display as claimed in claim 9, wherein the reflection region is surrounded by the transmission region.

18. The liquid crystal display as claimed in claim 9, wherein the transmission region is bent.

19. The liquid crystal display as claimed in claim 9, wherein the reflection region is bent.

20. A liquid crystal display comprising:
a first substrate;
a second substrate;
a liquid crystal layer between the first and second substrates;
a plurality of color filter units formed at the first substrate, each of the color filter units comprising a plurality of non-vertical type pixel color filters; and
a plurality of pixel electrodes formed at the second substrate at positions in one-to-one correspondence with the pixel color filters.
